(19) United States
(12) Patent Application Publication
(10) Pub. No.: US 2026/0239083 A1
(43) Pub. Date: Aug. 13, 2026

(54) NETWORK DEVICES AND METHODS FOR COMMUNICATIONS

(71) Applicant: Lenovo (Beijing) Limited, Beijing (CN)

(72) Inventors: Haiyan Luo, Shanghai (CN); Mingzeng Dai, Shanghai (CN); Genadi Velev, Darmstadt (DE)

(73) Assignee: Lenovo (Beijing) Limited, Beijing (CN)

(21) Appl. No.: 19/471,643

(22) PCT Filed: Apr. 7, 2023
(86) PCT No.: PCT/CN2023/086841

§ 371 Date: Oct. 1, 2025

(51) Int. Cl. H04W 24/10; H04W 28/02

(52) U.S. Cl. CPC H04W 24/10; H04W 28/0268

(57) ABSTRACT

Embodiments of the present disclosure relate to a solution for communications. In one aspect of the solution, a first network device obtains a first indication indicating that usage data for a QoS flow of a terminal device is to be collected and reported. The first network device collects the usage data based on the first indication. In turn, the first network device transmits, to a second network device, a usage data report associated with the collected usage data.

### FIELD

Embodiments of the present disclosure generally relate to the field of communication, and in particular to network devices and methods for communications.

### BACKGROUND

For Extended Reality (XR) and media traffic, a concept of a Protocol Data Unit (PDU) set is introduced. A PDU set may comprise one or more PDUs carrying a payload of one unit of information generated at an application level. For example, the unit of information may be a frame or video slice for XR services. Based on the concept of the PDU set, a Session Management Function (SMF) provides Radio Access Network (RAN) node with a Quality of Service (QoS) profile which includes both legacy QoS parameters and PDU set QoS parameters for QoS flows supporting PDU set based QoS handling (which is also called PDU set handling).

It may be assumed that charging rate may be different for data with PDU set handling and without PDU set handling. Therefore, it is necessary to collect and report usage data separately for data with PDU set handling and data without PDU set handling.

### SUMMARY

In general, embodiments of the present disclosure provide a solution for communications.

In a first aspect, there is provided a first network device. The first network device comprises a processor and a transceiver coupled to the processor. The processor is configured to: obtain a first indication indicating that usage data for a QoS flow of a terminal device is to be collected and reported; collect the usage data based on the first indication; and transmit, via the transceiver to a second network device, a usage data report associated with the collected usage data.

In a second aspect, there is provided a second network device. The second network device comprises a processor and a transceiver coupled to the processor. The processor is configured to: receive a usage data report via the transceiver from a first network device or a fourth network device, the usage data report being associated with at least one of first usage data and second usage data for a QoS flow of a terminal device served by the first network device; and identify at least one of the following: the first usage data to which PDU set handling is applied, or the second usage data to which the PDU set handling is not applied.

In a third aspect, there is provided a fourth network device. The fourth network device comprises a processor and a transceiver coupled to the processor. The processor is configured to: obtain a differentiating usage data report indicator indicating that at least one of first usage data and second usage data for a QoS flow of a terminal device is to be collected and reported, wherein PDU set handling is applied to the first usage data and the PDU set handling is not applied to the second usage data; receive an indication from a first network device serving the terminal device or from a second network device, wherein the indication indicates whether the PDU set handling is activated; collect at least one of the first usage data and the second usage data based on the differentiating usage data report indicator and the indication; and transmit, to the second network device, a usage data report associated with the at least one of the first usage data and the second usage data.

In a fourth aspect, there is provided a method performed by a first network device. The method comprises: obtaining a first indication indicating that usage data for a QoS flow of a terminal device is to be collected and reported; collecting the usage data based on the first indication; and transmitting, to a second network device, a usage data report associated with the collected usage data.

In a fifth aspect, there is provided a method performed by a second network device. The method comprises: receiving a usage data report from a first network device or a fourth network device, the usage data report being associated with at least one of first usage data and second usage data for a QoS flow of a terminal device served by the first network device; and identifying at least one of the following: the first usage data to which PDU set handling is applied, or the second usage data to which the PDU set handling is not applied.

In a sixth aspect, there is provided a method performed by a fourth network device. The method comprises: obtaining a differentiating usage data report indicator indicating that at least one of first usage data and second usage data for a QoS flow of a terminal device is to be collected and reported, wherein PDU set handling is applied to the first usage data and the PDU set handling is not applied to the second usage data; receiving an indication from a first network device serving the terminal device or from a second network device, wherein the indication indicates whether the PDU set handling is activated; collecting at least one of the first usage data and the second usage data based on the differentiating usage data report indicator and the indication; and transmitting, to the second network device, a usage data report associated with the at least one of the first usage data and the second usage data.

In a seventh aspect, there is provided a computer readable medium. The computer readable medium has instructions stored thereon. The instructions, when executed on at least one processor of a device, causing the device to perform the method of the fourth, fifth or sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings in which:

FIG. 1 illustrates a schematic diagram of a communication environment in which some embodiments of the present disclosure can be implemented;

FIG. 2 illustrates a signaling chart illustrating an example process for communications in accordance with some embodiments of the present disclosure;

FIG. 3 illustrates a signaling chart illustrating an example process for communications in accordance with some other embodiments of the present disclosure;

FIG. 4 illustrates a signaling chart illustrating an example process for communications in accordance with other embodiments of the present disclosure;

FIG. 5 illustrates a signaling chart illustrating an example process for communications in accordance with still other embodiments of the present disclosure;

FIG. 6 illustrates a signaling chart illustrating an example process for communications in accordance with yet other embodiments of the present disclosure;

FIG. 7 illustrates a signaling chart illustrating an example process for communications in accordance with yet other embodiments of the present disclosure;

FIG. 8 illustrates a flowchart of a method implemented at a first network device in accordance with some embodiments of the present disclosure;

FIG. 9 illustrates a flowchart of a method implemented at a second network device in accordance with other embodiments of the present disclosure;

FIG. 10 illustrates a flowchart of a method implemented at a fourth network device in accordance with some embodiments of the present disclosure; and

FIG. 11 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatuses are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The use of an expression such as “A and/or B” can mean either “only A” or “only B” or “both A and B.” Other definitions, explicit and implicit, may be included below.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VOIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As described above, for XR and media traffic, the concept of the PDU set is introduced. Based on the concept of the PDU set, SMF provides RAN node with the QoS Profile which includes both legacy QoS parameters and PDU set QoS parameters for QoS flows requests for PDU set handling.

PDU set handling is introduced in both Fifth Generation Core (5GC) side and RAN node side. At the 5GC side, SMF instructs PDU Session Anchor (PSA) User Plane Function (UPF) to perform PDU set handling (i.e., PDU set identification and marking). That is, PSA UPF identifies a PDU set based on the information contained in application protocol, for example, parameters contained in Real-time Transport Protocol (RTP) or Secure Real-time Transport Protocol (SRTP) header. After that, PSA UPF inserts PDU set information into General Packet Radio Service (GPRS) Tunnel Protocol-User Plane (GTP-U) header of N3/N9 tunnel, which includes PDU set Sequence Number, PDU Sequence Number within a PDU set, indication of End PDU of the PDU set, PDU set size in bytes (optional) and PDU set importance. At the RAN node side, the RAN node obtains PDU set information contained in GTP-U header of N3 tunnel and identifies PDUs of one PDU set. Besides, the RAN node performs PDU set handling based on PDU set QoS parameters provided by SMF.

PDU set handling feature may not be homogenously supported in the network. For example, a legacy RAN node may not have the capability of PDU set handling. Besides, even if an RAN node supports PDU set handling, it may still decide not to perform PDU set handling based on its status, such as the network load and other factors. It is assumed that PDU set handing is an on-top feature. The RAN node may accept the QoS flow with only legacy QoS parameters. That is, XR traffic can survive in 5G network without PDU set handling. Thus, there are the following two use cases.

A first use case is that the RAN node and UPF are aligned at PDU set handling, i.e., they activate and deactivate PDU set handling at a similar time.

A second use case is that UPF always performs PDU set handling for XR traffic. However, PDU set handing at the RAN node may change upon mobility. For example, UE may move from a source RAN node which supports PDU set handling to a target RAN node which does not support PDU set handling. RAN node supports PDU set handling is also referred to as supporting RAN node. RAN node does not support PDU set handling is also referred to as non-supporting RAN node.

It may be assumed that charging rate may be different for data with PDU set handling and without PDU set handling. Therefore, the first issue may be how to collect and report usage data separately for data with PDU set handling and data without PDU set handling.

Based on the concept of the PDU set, the PDU Set Integrated Handling Information (PSIHI) indicates whether all PDUs of the PDU Set are needed for the usage of the PDU Set by the application layer in the receiver side. SMF indicates the RAN node which QoS flow is associated with PSIHI. In case of congestion or the RAN node determines that some PDUs of one PDU set have been lost, the RAN node may decide to drop the whole PDU set. Therefore, the second issue may be as below: if the DL PDU Set eligible dropping by the NG-RAN is applied, the charging offset issue can be addressed during the normative work.

In view of the above, embodiments of the present disclosure provide a solution for communications. In this solution, a first network device obtains a first indication indicating that usage data for a QoS flow of a terminal device is to be collected and reported. Then, the first network device collects the usage data based on the first indication. In turn, the first network device transmits, to a second network device, a usage data report associated with the collected usage data. In this way, collection and report of usage data may be achieved by an RAN node.

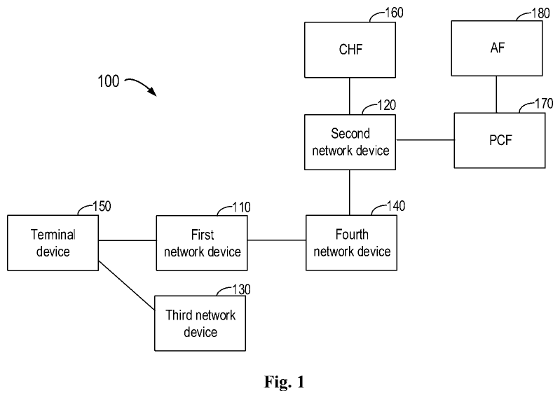

Hereinafter, principle of the present disclosure will be described with reference to FIGS. 1 to 11.

FIG. 1 illustrates a schematic diagram of a communication environment 100 in which some embodiments of the present disclosure can be implemented. The environment 100 may comprise a first network device 110, a second network device 120, a third network device 130, a fourth network device 140, a terminal device 150, a Charging Function (CHF) 160, a Policy Control Function (PCF) 170 and an Application Function (AF) 180.

In some embodiments, each of the first network device 110 and the third network device 130 may be implemented as a network device in a radio access network (RAN) or RAN node, such as a gNB.

In some embodiments, each of the second network device 120 and the fourth network device 140 may be implemented as a network device in a core network. For example, the second network device 120 may be implemented as an SMF and the fourth network device 140 may be implemented as a UPF. In such embodiments, the first network device 110 may communicate with the second network device 120 via the fourth network device 140 or an Access and Mobility management Function (AMF).

In some embodiments, the terminal device 150 may operate in a dual connectivity (DC) mode. In the DC mode, the terminal device 150 may communicate with the first network device 110 and the third network device 130 simultaneously. In such embodiments, one of the first network device 110 and the third network device 130 may be implemented as a Packet Data Convergence Protocol (PDCP) terminated node of a bearer, and the other may be implemented as a peer node. For example, one of the first network device 110 and the third network device 130 may be implemented as a Master Node (MN) and the other may be implemented as a Secondary Node (SN).

It is to be understood that the numbers of the network devices and terminal devices are only for ease of understanding without suggesting any limitations. The communication environment 100 may include any suitable number or type of the network devices and terminal devices adapted for implementing embodiments of the present disclosure.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G) or the future sixth generation (6G) wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

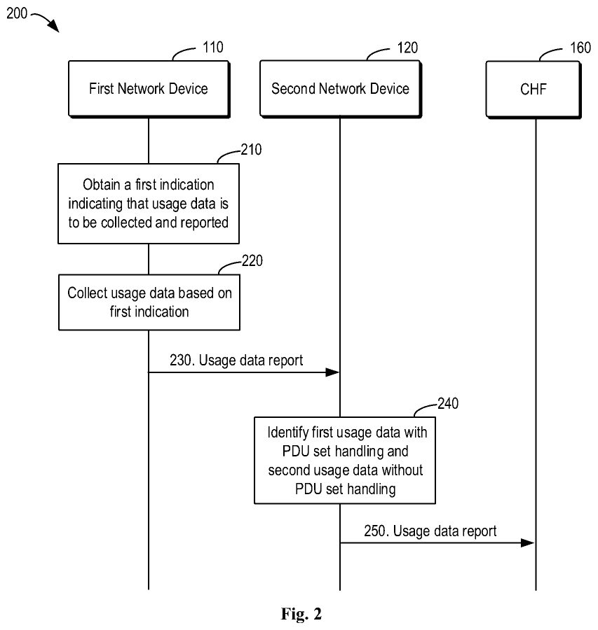

FIG. 2 illustrates a signaling chart illustrating an example process 200 for communications in accordance with some embodiments of the present disclosure. For the purpose of discussion, the process 200 will be described with reference to FIG. 1. The process 200 may involve the first network device 110, the second network device 120 and the CHF 160.

Generally, in the process 200, the first network device 110 (such as an RAN node) collects usage data and reports a usage data report associated with the collected usage data to the second network device 120 (such as an SMF). The process 200 may be applied to the first use case (UPF activates or deactivates PDU set handling aligned with RAN node) and the second use case (UPF always performs PDU set handling).

As shown in FIG. 2, the first network device 110 obtains 210 a first indication indicating that usage data for a QoS flow of the terminal device 150 is to be collected and reported.

In some embodiments, the first network device 110 may obtain the first indication by receiving a QoS profile associated with the QoS flow from the second network device 120. The QoS profile comprises PDU set QoS parameters QoS parameters. The PDU set PDU set QoS parametersindicate that the usage data is to be collected and reported. PDU set QoS parameters In such embodiments, if the QoS profile provided by the second network device 120 includes PDU set QoS parameters, it implies the first network device 110 to collect and report the usage data.

In some embodiments, upon receiving the PDU set QoS parameters, the first network device 110 may transmit an PDU set handling support indicator (or PDU set handling capability indicator) to the second network device 120. E.g., for PDU session modification procedure, SMF provides RAN node with PDU set QoS parameters associated with QoS flow in N2 SM information. Supporting RAN node responds with PDU set handling support indicator to SMF in N2 SM information. SMF infers whether RAN node support PDU set handling or not from presence/absence of PDU set handling support indicator in N2 SM information provided by RAN node. SMF then configures PSA UPF to perform PDU set handling (i.e., PDU set identification and marking) if RAN node supports PDU set handling. For handover procedure, target RAN node provides support PDU set handling support indicator if it supports regardless of whether PDU set QoS parameters are provided by source RAN node (solution #1). In this way, SMF infers that target RAN supports PDU set handling by receiving PSH-support indicator in Path Switch Request message (Xn handover) or Handover Request Acknowledge message (NGAP handover). SMF then triggers PDU session modification towards target RAN to provide PDU set QoS parameters. If PDU set handling at PSA UPF is already activated (e.g., UE moves from supporting RAN node to supporting RAN node), SMF does nothing. Otherwise if UE moves from non-supporting RAN node to supporting RAN node, SMF indicates PSA UPF to activate PDU set handling. Alternatively, SMF always provides PDU set QoS parameters to target RAN node as long as source RAN does not support PDU set handling (solution #2). E.g., SMF triggers PDU session modification procedure towards target RAN node by providing PDU set QoS parameters if it realizes that source RAN node does not support PDU set handling. Upon receiving PDU set QoS parameters, target RAN node then provides PDU set handling support indicator if it supports.

In some embodiments, upon receiving the PDU set QoS parameters, the first network device 110 may transmit an acceptance indication to the second network device 120. The acceptance indication indicates whether the PDU set QoS parameters are accepted.

In some embodiments, the PDU set QoS parameters may further indicate that differentiated usage data is to be collected and reported. The differentiated usage data may comprise at least one of the following: first usage data to which PDU set handling is applied, or second usage data to which the PDU set handling is not applied. Hereinafter, for brevity, “first usage data to which PDU set handling is applied” is also referred to as “first usage data with PDU set handling” while “second usage data to which the PDU set handling is not applied” is also referred to as “second usage data without PDU set handling”.

In some embodiments, the PDU set handling may comprise PDU set identification and marking for XR traffic.

Alternatively, in some embodiments, the first indication may comprise a pre-configured usage data report indicator indicating that the usage data is to be collected and reported. For example, the usage data report indicator may be pre-configured by Operations Administration and Maintenance (OAM) or Public Land Mobile Network (PLMN) with a service template and the associated usage data information. The service template may be at least one of the following: Data Network Name (DNN), Single Network Slice Selection Assistance Information (S-NSSAI), application identifier, IP-3 tuple or IP-5 tuple range. Usage data information may include usage data report indicator and reporting trigger which will be described later. IP-5 tuple range means that the IP address of the server is fixed, but the IP address of UE can be in the given IP range.

Alternatively, in some embodiments, the first network device 110 may obtain the first indication by receiving a usage data report indicator from the second network device 120. The usage data report indicator indicates that the usage data is to be collected and reported.

In some embodiments, the usage report indicator may be associated with PDU session identifier (ID) or (PDU session ID, at least one QoS Flow Identifier (QFI)). There may be the following three options with which the second network device 120 obtains usage data information for specific service data flow.

Option #1-1: the AF 180 provides the PCF 170 with flow description and the associated usage data information (via NEF). The PCF 170 provides the second network device 120 with service data flow template and the associated differentiating usage data information, which may include any one of the usage data indicator, a first reporting trigger and/or new threshold.

Option #1-2: the CHF 160 may provide the second network device 120 with the service template and the associated differentiating usage data information.

Option #1-3: the second network device 120 may be pre-configured by OAM/PLMN with service template and the associated differentiating usage data information.

Upon receiving the PDU session ID or (PDU session ID, at least one QFI), the associated usage report indicator and the first reporting trigger from the second network device 120, the first network device 110 may start to collect usage data for specific PDU session or specific QoS flow(s).

Generally, it is assumed that the first network device 110 may not change PDU set handling when the terminal device 150 connects. There are still some exceptions in case of DC when an MN (such as the first network device 110) and an SN (such as the third network device 130) have different handling for XR traffic, for example, one supports PDU set handling and the other does not. It is assumed that the first network device 110 exchanges PDU set handling support indicator with the third network device 130 upon Xn interface setup or upon handover or upon SN addition or modification. PDU set handling support indicator may be explicitly provided or implied by other Information Element (IE). For example, if the QoS profile contains PDU set QoS parameters, it implies the requirement of PDU set handling. Assume that MN does not support PDU set handling while the SN supports. Before SN addition, MN does not perform PDU set handling for XR traffic and collects the second usage data without PDU set handling. After SN addition, MN may decide to offload the QoS flow with PDU set QoS parameters towards SN. Alternatively, SN provides SMF the PDU set handling support indicator via MN. SMF further provides SN the PDU set QoS parameters associated with QoS flow via MN. As long as SN accepts QoS flow with PDU set QoS parameters, PDU set handling is applied for XR traffic later. When MN receives SECONDARY RAT DATA USAGE REPORT from SN, MN marks it as first usage data with PDU set handling.

In some embodiments, the usage data report indicator indicates that differentiated usage data is to be collected and reported. The differentiated usage data may comprise at least one of the following: first usage data to which PDU set handling is applied, or second usage data to which the PDU set handling is not applied.

In some embodiments, either to report the usage data or to report the differentiated usage data may be pre-defined or decided by the first network device 110.

With continued reference to FIG. 2, the first network device 110 collects 220 the usage data based on the first indication.

In turn, the first network device 110 transmits 230, to the second network device 120, a usage data report associated with the collected usage data.

In some embodiments, the first network device 110 may transmit the usage data report if a first reporting trigger for the usage data report is met. The first reporting trigger may comprise one of the following:
PDU set handling changes,
handover of the terminal device 150 is performed,
the third network device 130 serving the terminal device 150 is added or modified, or
the terminal device 150 enters a Radio Resource Control (RRC)-inactive mode or an RRC-idle mode.

In some embodiments, if the first network device 110 changes the PDU set handling from activation to deactivation, the PDU set handling changes. Alternatively, if the first network device 110 changes the PDU set handling from deactivation to activation, the PDU set handling changes.

In some embodiments, the third network device 130 may act as an SN and serve the terminal device 150. In such embodiments, if the SN is added or modified, the first network device 110 may transmit the usage data report to the second network device 120.

In some embodiments, the first reporting trigger may be pre-defined or pre-configured by OAM or PLMN. Alternatively, the first network device 110 may receive the first reporting trigger from the second network device 120. For example, the first network device 110 may receive the first reporting trigger together with the usage data report indicator. Alternatively, the first network device 110 may receive the first reporting trigger separately from the usage data report indicator.

In some embodiments, the usage report from the first network device 110 may be contained in N2 SM information, which is sent from the first network device 110 to the second network device 120 via AMF. Alternatively, the first network device 110 may provide the usage report to the second network device 120 via the fourth network device 140.

In some embodiments, there may be the following three options for usage data report.

Option #2-1: the first network device 110 provide a single usage report without indicating whether PDU set handling is applied or not.

For example, the usage report may include start timestamp, end timestamp, usage count uplink (UL) and usage count downlink (DL) for each QoS flow. If PDU set handling changes during the time when the terminal device 150 connects to the first network device 110, the first network device 110 may calculate a unified usage data based on the following equation as long as the second network device 120 or OAM/PLMN configures or pre-configures the first network device 110 with a ratio #1 for usage data with or without PDU set handling,

$$Usage data = ratio \#1 * usage data \#1 with PDU set handling + usage data \#2 without PDU set handling \qquad ( 1 ‐ 1 )$$

As mentioned before, the first network device 110 may not change PDU set handling when the terminal device 150 connects. But the exception happens in case of DC. In this case, usage data #1 with PDU set handling may happen in MN (for example, the first network device 110). Usage data #2 without PDU set handling may happen in SN (for example, the third network device 110), and usage data #2 without PDU set handling is reported by SN. In another case, usage data #1 with PDU set handling may happen in SN, and usage data #1 with PDU set handling is reported by SN. Usage data #2 without PDU set handling may happen in MN.

If DC is performed, SN provides SECONDARY RAT DATA USAGE REPORT to MN. It is assumed that MN and SN are aligned on PDU set handling. Besides, it is assumed that the second network device 120 or OAM/PLMN may configure or pre-configure the first network device 110 with a ratio #2 for SN. In this case, the first network device 110 may calculate a unified usage data based on the following equation:

$$Usage data = ratio \#2 * usage data for SN + usage data for MN \qquad ( 1 ‐ 2 )$$

If both ratio #1 and ratio #2 are configured, the first network device 110 may calculate a unified usage data based on the following equation. It is assumed that only MN and SN are aligned on PDU set handling, the first network device 110 provides usage report only without indicating whether PDU set handling is applied or not. Otherwise, option #2-2 or option #2-3 may be applied. In this case, if PDU set handling is applied, then

$$Usage data = ratio \#1 * ( ratio \#2 * usage data for SN + usage data for MN ) \qquad ( 1 ‐ 3 )$$

Otherwise, if PDU set handling is not applied, equation (1-2) is applied.

Option #2-2: the first network device 110 provides the usage report by indicating whether PDU set handling is applied or not.

In Example #1 of Option #2-2, in order to transmit the usage data report, the first network device 110 may transmit the first usage data with PDU set handling in a first IE associated with PDU set handling and transmit second usage data without PDU set handling in a second IE associated with non-PDU set handling. For example, the usage data report may include start timestamp, end timestamp, usage count UL #1 with PDU set handling, usage count UL #2 without PDU set handling, usage count DL #1 with PDU set handling and usage count DL #2 without PDU set handling for each QoS flow. Alternatively, the start timestamp and end timestamp may be associated with the first usage data with PDU set handling and the second usage data without PDU set handling, respectively.

In Example #2 of Option #2-2, the usage data report may comprise at least one of the following: first usage data and a second indication indicating that PDU set handling is applied to the first usage data, or second usage data and a third indication indicating that the PDU set handling is not applied to the second usage data. For example, the second indication and the third indication may be implemented as a PDU set handling indicator. If the PDU set handling indicator is true or 1, it means that PDU set handling is applied to the first usage data. If the PDU set handling indicator is false or 0, it means that PDU set handling is not applied to the second usage data.

In a variant of Example #2, the existing usage data IE may be reused, and a new indicator may be introduced into the usage data report. If the first usage data is reported together with a PDU set handling indicator (i.e., the second indication), it means that PDU set handling is applied to the first usage data. If the second usage data is reported without the PDU set handling indicator (i.e., the third indication), it means that PDU set handling is not applied to the second usage data.

In Example #3 of Option #2-2, the usage data report may comprise the usage data and one of the following: a first percentage of the usage data with PDU set handling, or a second percentage of the usage data without PDU set handling. For example, if the first percentage of usage data with PDU set handling is provided as P, the usage data with PDU set handling may be calculated based on the following equation:

$$Usage data with PDU set handling = P * usage data \qquad ( 1 ‐ 4 )$$

The usage data without PDU set handling may be calculated based on the following equation:

$$Usage data without PDU set handling = ( 1 - P ) * usage data \qquad ( 1 ‐ 5 )$$

Option #2-3: in case of DC, the first network device 110 may provide usage data for MN and SN, respectively. For example, the usage data report may comprise at least one of the following: third usage data for the first network device 110 (for example, MN), or fourth usage data for the third network device 130 (for example, SN) serving the terminal device 150.
Option 2-3A: if PDU set handling remains the same before and after SN addition or modification, the first network device 110 may provide usage data for MN and usage data for SN respectively without indicating whether PDU set handling is applied or not. For example, the usage report includes usage data #1 for MN and usage data #2 for SN.
Option 2-3B: if PDU set handling changes upon SN addition or modification, the first network device 110 may provide usage data for MN and SN respectively by indicating whether PDU set handling is applied or not. For example, the first network device 110 may provide usage data #1 without PDU set handling for MN and usage data #2 with PDU set handing for SN. If MN or SN changes PDU set handling when the terminal device 150 connects, the first network device 110 may provide usage data with/without PDU set handling for MN, and usage data with/without PDU set handling for SN respectively. Usage data may be in the form of one of Example #1, Example #2 and Example #3.

With continued reference to FIG. 2, upon receiving the usage data report from the first network device 110, the second network device 120 identifies 240 at least one of the following: the first usage data with PDU set handling, or the second usage data without PDU set handling.

In some embodiments, the second network device 120 may receive an acceptance indication from the first network device 110. The acceptance indication may indicate whether PDU set QoS parameters in a QoS profile associated with the QoS flow are accepted. Alternatively, the acceptance indication may indicate whether the whole QoS profile is accepted. In turn, the second network device 120 may identify at least one of the first usage data and the second usage data based on the acceptance indication.

For example, the first network device 110 may indicate the second network device 120 that the whole QoS profile is accepted, or only the legacy QoS parameters are accepted. Alternatively, the first network device 110 may indicate the second network device 120 that PDU set QoS parameters are not accepted.

Alternatively, the first network device 110 may not transmit the acceptance indication to the second network device 120. The second network device 120 may determine that PDU set QoS parameters cannot be fulfilled when no acceptance indication provided by the first network device 110. In this way, the second network device 120 is still able to determine whether PDU set handling is applied or not from a response of the first network device 110.

In some embodiments, if no acceptance indication is provided by the first network device 110 or the first network device 110 indicates that PDU set QoS parameters are not accepted, the second network device 120 may inform the fourth network device 140 to deactivate PDU set handling (i.e., PDU set identification and marking). For example, the second network device 120 informs the fourth network device 140 to deactivate PDU set handling by setting PDU set information (or PDU set identification and marking) to false or zero. Specifically, if PDU set handling at the fourth network device 140 has not been activated yet, the second network device 120 decides not to activate the fourth network device 140 to perform PDU set handling. If the first network device 110 indicates that PDU set QoS parameters are accepted, the second network device 120 may inform the fourth network device 140 to activate PDU set handling. For example, the second network device 120 informs the fourth network device 140 to activate PDU set handling by setting PDU set information (or PDU set identification and marking) to true or 1. If the first network device 110 indicates that PDU set QoS parameters cannot be accepted or fulfilled (or there is no PDU set handling support indicator), the second network device 120 may further inform the PCF 170 that the PDU set QoS parameters of which service data flow (or which PCC rule, or which data flow) cannot be supported. The PCF 170 may further inform the AF 180 the PDU set QoS parameters of which application data flow cannot be supported (via NEF). When the terminal device 150 moves to coverage of the first network device 110 which supports PDU set handling, the first network device 110 indicates the second network device 120 that PDU set QoS parameters can be accepted or fulfilled (or there is PDU set handling support indicator). The second network device 120 may further indicate the PCF 170 that PDU set QoS parameters of which service data flow (or which PCC rule, or which data flow) can be supported. The PCF 170 may further indicate the AF 180 that the PDU set QoS parameters of which application data flow can be supported (via NEF).

Alternatively, as described in Example #1 of Option #2-2, the first network device 110 may transmit the first usage data with PDU set handling in a first IE associated with PDU set handling and transmit second usage data without PDU set handling in a second IE associated with non-PDU set handling. In such embodiments, if the first usage data is received in the first IE associated with the PDU set handling, the second network device 120 may identify the first usage data with PDU set handling. If the second usage data is received in the second IE associated with non-PDU set handling, the second network device 120 may identify the second usage data without PDU set handling.

Alternatively, as described in Example #2 of Option #2-2, the usage data report from the first network device 110 may comprise at least one of the following: first usage data and a second indication indicating that PDU set handling is applied to the first usage data, or second usage data and a third indication indicating that the PDU set handling is not applied to the second usage data. Thus, the second network device 120 may identify the first usage data with PDU set handling based on the second indication and identify the second usage data without PDU set handling based on the third indication.

Alternatively, as described in Option #2-3B, the first network device 110 may provide usage data for MN and SN respectively by indicating whether PDU set handling is applied or not. Thus, the second network device 120 may identify the usage data for MN with or without PDU set handling and the usage data for SN with or without PDU set handling based on the indication from the first network device 110.

For option #2-1 and option #2-3A as described above, the first network device 110 does not indicate whether PDU set handling is applied or not in the usage data report. In such embodiments, the first network device 110 may transmit a support indication to the second network device 120. The support indication indicates PDU set handling is supported by the first network device 110. Hereinafter, the support indication is also referred to as “PDU set handling support indicator”. For example, the first network device 110 may provide the second network device 120 with the PDU set handling support indicator upon PDU session establishment or modification or upon handover procedure. If the PDU set handling support indicator is true, the second network device 120 may determine that PDU set handling is applied for specific QoS flow(s). If the PDU set handling support indicator is false, the second network device 120 may determine that PDU set handling is not applied for specific QoS flow(s). In other words, the second network device 120 may determine whether PDU set QoS parameters are accepted by the first network device 110 based on determination that PDU set handling support indicator is true or false.

Alternatively, the second network device 120 may determine that PDU set handling is applied for specific QoS flow(s) from the presence of PDU set handling support indicator and determine that PDU set handling is not applied for specific QoS flow(s) from the absence of the PDU set handling support indicator. In other words, the second network device 120 may determine whether PDU set QoS parameters are accepted by the first network device 110 based on whether PDU set handling support indicator is provided or not.

In some embodiments, the second network device 120 provides the first network device 110 with a QoS profile associated with a QoS flow, which contains both legacy QoS parameters and PDU set QoS parameters. The second network device 120 may receive PDU set handling support indicator from the first network device 110. If the first network device 110 informs the second network device 120 the QoS flow is accepted, then the PDU set handling support indicator may indicate PDU set QoS parameters in a QoS profile associated with the QoS flow are accepted. In other words, both PDU set QoS parameters and legacy QoS parameters are accepted. If no PDU set handing support indicator is provided by the first network device 110 and the first network device 110 informs the second network device that it accepts the QoS flow, the second network device 120 infers that only the legacy QoS parameters in a QoS profile associated with the QoS flow are accepted.

Return to FIG. 2, the second network device 120 transmits 250 a usage data report to the CHF 160. There may be two options for the second network device 120 to transmit a usage data report.

Option #3-1: the second network device 120 may report usage data by indicating whether PDU set handling is applied or not, in the form of one of Example #1, Example #2 of Example #3 as described above. The CHF 160 may perform differentiating charging for usage data with PDU set handling and without PDU set handling respectively.

Option #3-2: the second network device 120 may calculate a unified usage data by considering the ratio for usage data with PDU set handling (or a ratio for usage data without PDU set handling). It is assumed that the ratio for usage data with PDU set handling is provided by the CHF 160 or the PCF 170 or by pre-configuration. For example, the CHF 160 or the PCF 170 may provide the second network device 120 with the ratio for usage data with PDU set handling for at least one of specific DNN, S-NSSAI, application ID, IP-3 tuple or IP-5 tuple range and so on. The second network device 120 calculates a unified usage data based on the equation (1-1) as described above.

In case of DC, there may be three options for the second network device 120 to transmit a usage data report.

Option #4-1: the second network device 120 may report usage data by indicating whether PDU set handling is applied or not (for example, in the form of Example #1, Example #2 of Example #3 as described above) for MN and SN respectively. The CHF 160 performs differentiating charging for usage data with PDU set handling and usage data without PDU set handling respectively. Besides, the CHF 160 also performs differentiating charging for MN and SN respectively.

Option #4-2: the second network device 120 calculates a unified usage data by considering the ratio #1 for usage data with PDU set handling (or a ratio for usage data without PDU set handling). The second network device 120 calculates a unified usage data for MN and SN respectively based on the equation (1-1) and provides the CHF 160 the usage data for MN and usage data for SN respectively.

Option #4-3: the second network device 120 calculates a unified usage data by considering the ratio #1 for usage data with PDU set handling and ratio #2 for SN. The second network device 120 calculates a unified data based on the following equation:

$$Usage data = ratio \#1 * ( ratio \#2 * usage data \#1 for SN with PDU set handling + usage data \#2 for MN with PDU set handling ) + ratio \#2 * usage data \#3 for SN without PDU set handling + usage data \#4 for MN without PDU set handling \qquad ( 1 ‐ 6 )$$

This embodiment can also be used to resolve the second issue. That is, if DL PDU set eligible dropping by the NG-RAN is applied, the usage data reported by the first network device 110 has already subtracted the dropped packet volume. The second network device 120 may directly forward the usage data report from the first network device 110 to the CHF 160 without the identification made at 240.

In some embodiments, the fourth network device 140 (such as a UPF) may collect usage data and report a usage data report associated with the collected usage data to the second network device 120 (such as an SMF). Such embodiments can be applied to both the first use case (UPF activates/deactivates PDU set handling aligned with the RAN node) and the second use case (UPF always performs PDU set handling). It targets to solve the first issue.

Based on whether the second network device 120 or the first network device 110 indicates to activate (i.e., start) or deactivate (i.e., stop) PDU set handling, there may be two cases:
A-1: the second network device 120 indicates to activate (i.e., start) or deactivate (i.e., stop) PDU set handling
A-2: the first network device 110 indicates to activate (i.e., start) or deactivate (i.e., stop) PDU set handling

Based on whether it has impact on reporting of usage data by the fourth network device 140, there may be two cases:
B-1: The fourth network device 140 reports first usage data with PDU set handling and/or second usage data without PDU set handling
B-2: The fourth network device 140 reports usage data as it is in prior art without differentiating first usage data with PDU set handling and second usage data without PDU set handling

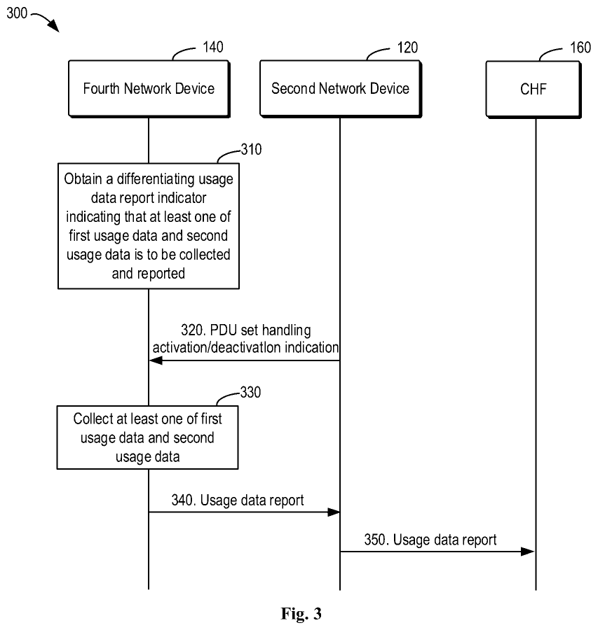

In summary, any one of cases A1 and A2 may be combined with any one of cases B-1 and B-2. This will be described with reference to FIGS. 3 to 6.

FIG. 3 illustrates a signaling chart illustrating an example process 300 for communications in accordance with some embodiments of the present disclosure. For the purpose of discussion, the process 300 will be described with reference to FIG. 1. The process 300 may involve the fourth network device 140, the second network device 120 and the CHF 160.

Generally, in the process 300, the fourth network device 140 (such as a UPF) collects usage data and reports a usage data report associated with the collected usage data to the second network device 120 (such as an SMF). The process 300 may be considered as a combination of case A-1 and case B-1. That is, in the process 300, the second network device 120 indicates the fourth network device 140 to activate or deactivate PDU set handling. The fourth network device 140 performs differentiating usage data collection and report for usage data with PDU set handling and usage data without PDU set handling. The process 300 has impacts on reporting usage data by the fourth network device 140. That is, the fourth network device 140 reports at least one of the first usage data with PDU set handling and the second usage data without PDU set handling.

As shown in FIG. 3, the fourth network device 140 obtains 310 a differentiating usage data report indicator indicating that at least one of first usage data and second usage data for a QoS flow of the terminal device 150 is to be collected and reported. PDU set handling is applied to the first usage data and the PDU set handling is not applied to the second usage data.

In some embodiments, the fourth network device 140 may receive the differentiating usage data report indicator from the second network device 120. In such embodiments, the fourth network device 140 may receive, from the second network device 120, N4 Session Establishment/Modification Request which contains Packet Detection Rule (PDR) and the associated Usage Reporting Rule (URR). One of the PDR and the URR may comprise the differentiating usage data report indicator. The PDR is used to classify a packet into a specific QoS flow. Therefore, the differentiating usage data report indicator applies to a specific QoS flow.

Alternatively, the differentiating usage data report indicator may be pre-configured by OAM or PLMN.

Optionally, the second network device 120 may transmit 320, to the fourth network device 140, an indication indicating whether the PDU set handling is activated or deactivated. Hereinafter, for brevity, the “indication indicating whether the PDU set handling is activated or deactivated” is also referred to as “PDU set handling activation/deactivation indication”.

For example, upon PDU session establishment or modification procedure or upon handover procedure, the second network device 120 may transmit the PDU set handling activation/deactivation indication to the fourth network device 140 so as to indicate the fourth network device 140 to activate or deactivate PDU set handling. For example, the PDU set handling at PSA UPF may comprise PDU set identification and marking. The second network device 120 may make the decision based on whether the serving RAN node (such as the first network device 110) supports PDU set handling. For example, the second network device 120 informs the fourth network device 140 to activate PDU set handling for specific QoS flow when the first network device 110 supports PDU set handling. The second network device 120 informs the fourth network device 140 to deactivate PDU set handling for specific QoS flow when the first network device 110 does not support PDU set handling.

Upon receiving the differentiating usage data report indicator, the fourth network device 140 collects 330 at least one of the first usage data with PDU set handling and the second usage data without PDU set handling.

For example, if the second network device 120 indicates the fourth network device 140 to activate or start PDU set handling, the fourth network device 140 collects usage data and marked it with PDU set handling. If the second network device 120 indicates the fourth network device 140 to deactivate or stop PDU set handling, the fourth network device 140 collects usage data and marked it without PDU set handling. If no activate/deactivate indication is provided by the second network device 120, the fourth network device 140 collects usage data and marks it without PDU set handling.

In embodiments where the differentiating usage data report indicator is pre-configured, the fourth network device 140 may collect and report first usage data with PDU set handling and second usage data without PDU set handling upon receiving the PDU set handling activation/deactivation indication from the second network device 120. In addition, if no activate/deactivate indication is provided by the second network device 120, the fourth network device 140 collects usage data and marked it without PDU set handling.

In turn, the fourth network device 140 transmits 340, to the second network device 120, a usage data report associated with the at least one of the first usage data with PDU set handling and the second usage data without PDU set handling.

In some embodiments, the fourth network device 140 may transmit the usage data report when a second reporting trigger is met.

In some embodiments, the fourth network device 140 may receive the second reporting trigger from the second network device 120. In such embodiments, in order to provide the second reporting trigger to the fourth network device 140, the second network device 120 may obtain usage data information for specific service data flow in a similar way as described with reference to FIG. 2.

Alternatively, the second reporting trigger may be predefined or pre-configured.

In some embodiments, the second reporting trigger may comprise the PDU set handling changes. For example, if the fourth network device 140 changes the PDU set handling from activation to deactivation, the PDU set handling changes. Alternatively, if the fourth network device 140 changes the PDU set handling from deactivation to activation, the PDU set handling changes. In such embodiments, the usage data report may comprise the first usage data with PDU set handling or the second usage data without PDU set handling.

Alternatively, in some embodiments, the second reporting trigger may comprise a sum of a first volume of the first usage data with PDU set handling and a second volume of the second usage data without PDU set handling exceeds a volume threshold. Alternatively, the second reporting trigger may comprise time for handling the sum of the first volume and the second volume exceeds a time threshold. In such embodiments, the usage data report may comprise the first usage data with PDU set handling and the second usage data without PDU set handling. The form of the usage data report may be one of Example #1, Example #2 and Example #3 as described with reference to FIG. 2.

Alternatively, in some embodiments, thresholds for the first usage data with PDU set handling and the second usage data without PDU set handling may be defined respectively. In such embodiments, the second reporting trigger may comprise one of the following:
the first volume of the first usage data with PDU set handling exceeds a first volume threshold,
the second volume of the second usage data without PDU set handling exceeds a second volume threshold, first time for handling the first volume of the first usage data with PDU set handling exceeds a first time threshold, or
second time for handling the second volume of the second usage data without PDU set handling exceeds a second time threshold.

In embodiments where the second reporting trigger may comprise one of the above, the usage data report may comprise the first usage data with PDU set handling or the second usage data without PDU set handling.

In some embodiments, the second network device 120 may transmit, to the fourth network device 140, at least one of the following:
the volume threshold,
the time threshold,
the first volume threshold,
the second volume threshold,
the first time threshold, or
the second time threshold.

Alternatively, at least one of the above threshold may be predefined or preconfigured.

With continued reference to FIG. 3, upon receiving the usage data report from the fourth network device 140, the second network device 120 transmits 350 a usage data report to the CHF 160. Embodiments of the action 350 may be the same as those of the action 250 in FIG. 2. Details of these embodiments are omitted for brevity.

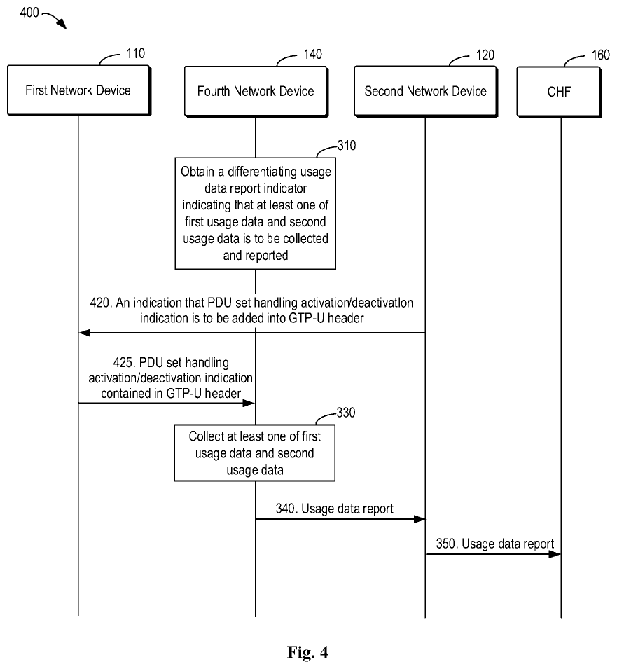

FIG. 4 illustrates a signaling chart illustrating an example process 400 for communications in accordance with some embodiments of the present disclosure. For the purpose of discussion, the process 400 will be described with reference to FIG. 1. The process 400 may involve the first network device 110, the fourth network device 140, the second network device 120 and the CHF 160.

Generally, in the process 400, the fourth network device 140 (such as a UPF) collects usage data and reports a usage data report associated with the collected usage data to the second network device 120 (such as an SMF). The process 400 may be considered as a combination of case A-2 and case B-1. That is, in the process 400, the first network device 110 (such as an RAN node) indicates the fourth network device 140 to activate or deactivate PDU set handling. The fourth network device 140 performs differentiating usage data collection and report for usage data with PDU set handling and usage data without PDU set handling. The process 400 has impacts on reporting usage data by the fourth network device 140. That is, the fourth network device 140 reports at least one of the first usage data with PDU set handling and the second usage data without PDU set handling.

Actions 310, 330, 340 and 350 in the process 400 are the same as those in the process 300. Details of these actions are omitted for brevity.

The process 400 is different from the process 300 in actions 420 and 425.

Specifically, the second network device 120 may transmit 420, to the first network device 110, an indication indicating the first network device 110 to insert the PDU set handling activation/deactivation indication in a GTP-U header of N3 tunnel of a UL packet or a dummy UL packet. The second network device 120 may transmit the indication to the first network device 110 upon PDU session establishment or modification or upon handover procedure. The first network device 110 may decide whether to perform PDU set handling or not based on its PDU set handling capability or status. In order to improve robustness, the PDU set handling activation/deactivation indication may be inserted in more than one GTP-U headers. If there are no UL packets, the first network device 110 may insert the PDU set handling activation/deactivation indication in a GTP-U header of at least one dummy UL packet. Alternatively, the first network device 110 is pre-configured to insert the PDU set handling activation/deactivation indication in a GTP-U header of N3 tunnel of a UL packet or a dummy UL packet. Specifically, the first network device 110 inserts the PDU set handling activation indication (or support indicator) in a GTP-U header of N3 tunnel of a UL packet or a dummy UL packet upon receiving PDU set QoS parameters from the second network device 120.

Upon receiving the indication from the second network device 120, the first network device 110 inserts the PDU set handling activation/deactivation indication in one or more GTP-U headers to inform the fourth network device 140 when to start or stop PDU set handling. Alternatively, the first network device 110 inserts the PDU set handling activation indication (or PDU set handling support indicator) in one or more GTP-U headers to inform the fourth network device 140 when to start PDU set handling (or whether PDU set handling is supported at the first network device 110 side). In turn, the first network device 110 transmits 425, to the fourth network device 140, the PDU set handling activation/deactivation indication (or PDU set handling activation indication only) contained in one or more GTP-U headers.

Upon receiving the PDU set handling activation/deactivation indication contained in one or more GTP-U headers from the first network device 110, the fourth network device 140 activates or deactivates PDU set handling (for example, PDU set identification and marking at the fourth network device 140) correspondingly. If no activation/deactivation indication is contained in GTP-U headers, the fourth network device 140 does not perform PDU set handling.

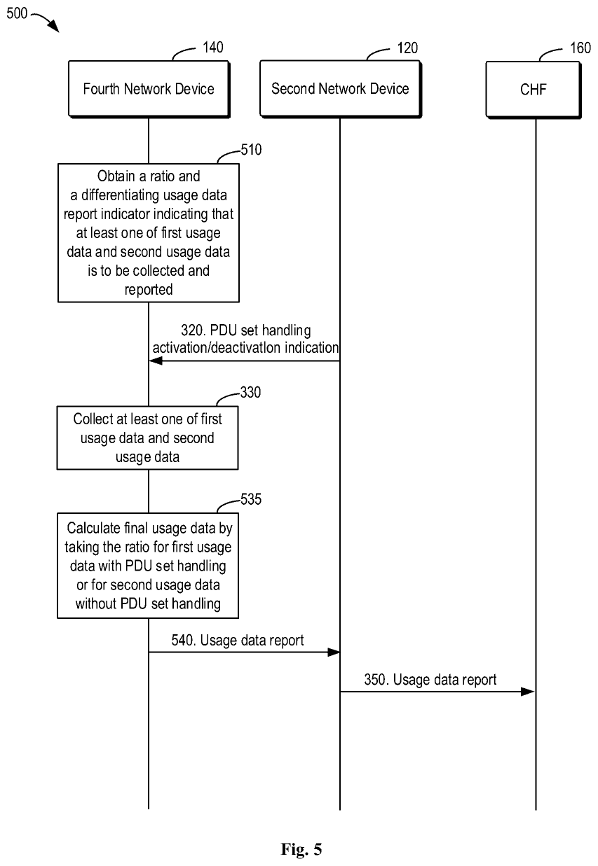

FIG. 5 illustrates a signaling chart illustrating an example process 500 for communications in accordance with some embodiments of the present disclosure. For the purpose of discussion, the process 500 will be described with reference to FIG. 1. The process 500 may involve the fourth network device 140, the second network device 120 and the CHF 160.

Generally, in the process 500, the fourth network device 140 (such as a UPF) collects usage data and reports a usage data report associated with the collected usage data to the second network device 120 (such as an SMF). The process 500 may be considered as a combination of case A-1 and case B-2. That is, in the process 500, the second network device 120 (such as an SMF) indicates the fourth network device 140 to activate or deactivate PDU set handling. The fourth network device 140 performs differentiating usage data collection and report for usage data with PDU set handling and usage data without PDU set handling. The process 500 has no impacts on reporting usage data by the fourth network device 140. That is, the fourth network device 140 reports usage data as it is in prior art without differentiating usage data with or without PDU set handling.

Actions 320, 330 and 350 in the process 500 are the same as those in the process 300. Details of these actions are omitted for brevity.

The process 500 is different from the process 300 in actions 510, 535 and 540.

Specifically, as shown in FIG. 5, the fourth network device 140 obtains 510 a differentiating usage data report indicator indicating that at least one of first usage data with PDU set handling and second usage data without PDU set handling for a QoS flow of the terminal device 150 is to be collected and reported.

In some embodiments, the fourth network device 140 may receive the differentiating usage data report indicator from the second network device 120. Alternatively, the differentiating usage data report indicator may be pre-configured by OAM or PLMN.

In addition, the fourth network device 140 also obtains 510 a ratio for the first usage data with PDU set handling or for the second usage data without PDU set handling.

In some embodiments, the fourth network device 140 may obtain the ratio from the second network device 120. Alternatively, the ratio may be preconfigured.

In some embodiments, the differentiated usage data indicator may be provided explicitly or implied by the ratio for the first usage data with PDU set handling or for the second usage data without PDU set handling. That is, the second network device 120 may provide the fourth network device 140 only with the ratio for the first usage data with PDU set handling or for the second usage data without PDU set handling. Upon receiving the ratio, the fourth network device 140 collects and reports at least one of the first usage data with PDU set handling and the second usage data without PDU set handling.

Upon collecting at least one of the first usage data with PDU set handling and the second usage data without PDU set handling, the fourth network device 140 calculates 535 final usage data by taking the ratio for the first usage data with PDU set handling or for the second usage data without PDU set handling. For example, the second network device 120 may provide the ratio for the first usage data with PDU set handling. Then, the four network device 140 calculates a unified usage data based on equation (1-1) as described above.

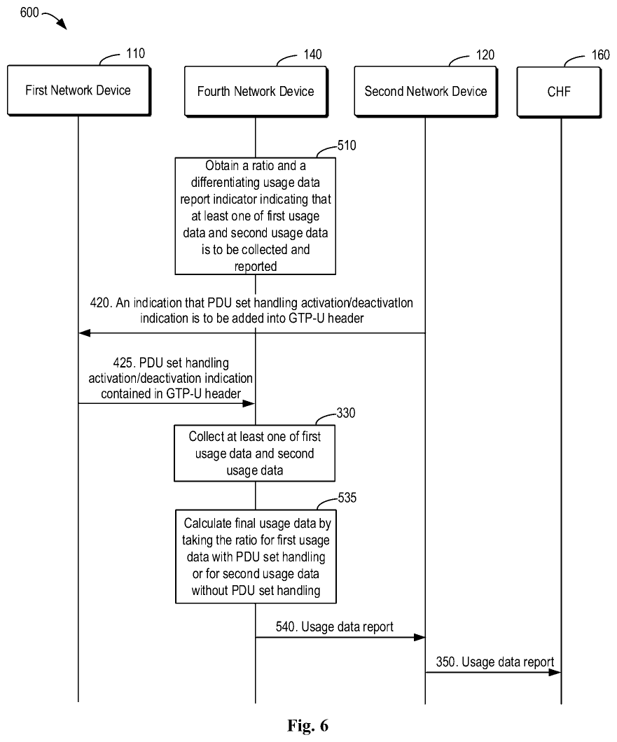

FIG. 6 illustrates a signaling chart illustrating an example process 600 for communications in accordance with some embodiments of the present disclosure. For the purpose of discussion, the process 600 will be described with reference to FIG. 1. The process 600 may involve the first network device 110, the fourth network device 140, the second network device 120 and the CHF 160.

Generally, in the process 600, the fourth network device 140 (such as a UPF) collects usage data and reports a usage data report associated with the collected usage data to the second network device 120 (such as an SMF). The process 600 may be considered as a combination of case A-2 and case B-2. That is, in the process 600, the first network device 110 (such as an RAN node) indicates the fourth network device 140 to activate or deactivate PDU set handling. The fourth network device 140 performs differentiating usage data collection and report for usage data with PDU set handling and usage data without PDU set handling. The process 600 has no impacts on reporting usage data by the fourth network device 140. That is, the fourth network device 140 reports usage data as it is in prior art without differentiating usage data with or without PDU set handling.

Actions 330 and 350 in the process 600 are the same as those in the process 300. Actions 420 and 425 in the process 600 are the same as those in the process 400. Actions 510, 535 and 540 in the process 600 are the same as those in the process 500. Details of these actions are omitted for brevity.

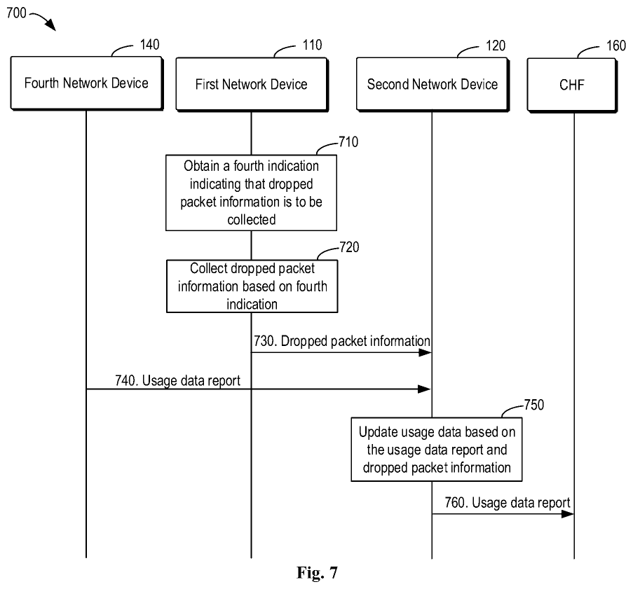

FIG. 7 illustrates a signaling chart illustrating an example process 700 for communications in accordance with some embodiments of the present disclosure. For the purpose of discussion, the process 700 will be described with reference to FIG. 1. The process 700 may involve the first network device 110, the second network device 120, the fourth network device 140 and the CHF 160.

Generally, in the process 700, the fourth network device 140 (such as a UPF) collects usage data and reports a usage data report associated with the collected usage data to the second network device 120 (such as an SMF). The first network device 110 (such as an RAN node) collects information about dropped packets and reports the information about dropped packets to the second network device 120 (such as an SMF). The process 700 may solve the second issue as described above.

As shown in FIG. 7, the first network device 110 obtains 710 a fourth indication indicating that information about dropped packets for a QoS flow of the terminal device 150 is to be collected and reported. Hereinafter, for brevity, the information about dropped packets is also referred to as “dropped packet information”.

In some embodiments, the first network device 110 may obtain the fourth indication by receiving a QoS profile associated with the QoS flow from the second network device 120. The QoS profile comprises PDU set QoS parameters. The PDU set QoS parameters indicates that the dropped packet information is to be collected and reported. In such embodiments, if the QoS profile provided by the second network device 120 includes PDU set QoS parameters, it implies the first network device 110 to collect and report the dropped packet information.

Alternatively, in some embodiments, the first network device 110 may obtain the fourth indication by receiving a dropped packet information report indicator from the second network device 120. The dropped packet information report indicator indicates that the dropped packet information is to be collected and reported.

Optionally, a dropped packet threshold may also be provided by the second network device 120 or pre-configured. The dropped packet threshold may be dropped packet volume threshold or dropped packet ratio threshold. For example, as long as the dropped packet volume exceeds the dropped packet volume threshold, the first network device 110 reports the dropped packet information. As long as dropped packet ratio exceeds the dropped packet ratio threshold, the first network device 110 reports the dropped packet information. The dropped packet ratio may be a ratio of the dropped packet volume to the transmitted packet volume, or a ratio of the dropped packet volume to the sum of transmitted packet volume and the dropped packet volume. Alternatively, the dropped packet ratio may be a ratio of the dropped packet (e.g., PDU or PDU set) number to the transmitted packet number, or a ratio of the dropped packet number to the sum of transmitted packet number and the dropped packet number. More than one dropped packet volume/ratio thresholds can be provided or pre-configured.

In some embodiments, the dropped packet information report indicator may be associated with PDU session ID or (PDU session ID, at least one QFI).

Upon receiving the PDU session ID or (PDU session ID, at least one QFI), the associated dropped packet information report indicator and the first reporting trigger from the second network device 120, the first network device 110 may start to collect 720 dropped packet information for specific PDU session or specific QoS flow(s). The first reporting trigger may be the same as the first reporting trigger which has been described with reference to FIG. 2.

Alternatively, in some embodiments, the fourth indication may comprise a pre-configured dropped packet information report indicator indicating that the dropped packet information is to be collected and reported. For example, the dropped packet information report indicator may be pre-configured by OAM or PLMN with a service template and the associated dropped packet information report indicator.

In turn, the first network device 110 transmits 730 the dropped packet information to the second network device 120.

In some embodiments, the dropped packet information may comprise an indication that a volume of the dropped packets exceeds a volume threshold or a dropped packet ratio exceeds a ratio threshold. In some embodiments, the dropped packet information may comprise the trigger or even the trigger threshold. For example, the dropped packet information may comprise the start timestamp, the stop timestamp, dropped packet volume threshold #1. If there is no threshold provided, the dropped packet information may comprise the start timestamp, the stop timestamp, the dropped packet volume or the dropped packet ratio.

The four network device 140 provides 740 the second network device 120 with the usage data report for specific QoS flow(s), which may comprise DL usage data.

The second network device 120 updates 750 usage data for the QoS flow based on the usage data report from the fourth network device 140 and the dropped packet information. In other words, the second network device 120 calculates usage data by considering both usage data report from the four network device 140 and the dropped packet information from the first network device 110.

For example, the second network device 120 may subtract the dropped packet volume from the DL usage data. Alternatively, the second network device 120 may calculate the final DL usage data by DL usage data times the dropped packet ratio. For example, both the first network device 110 and the four network device 140 may send, to the second network device 120, the usage data report upon handover. Then, it may be considered that the reports are target at the same time window. Besides, the second network device 120 may configure the first network device 110 and the four network device 140 to report at the same time with the same periodicity, then both reports can also be considered at the same time window. Thus, it is meaningful for the second network device 120 to do the subtraction.

In turn, the second network device 120 provides 750 a usage data report to the CHF 160.

FIG. 8 illustrates a flowchart of a method 800 implemented at a first network device in accordance with some embodiments of the present disclosure. For the purpose of discussion, the method 800 will be described from the perspective of the first network device 110 with reference to FIG. 1.

At block 810, the first network device 110 obtains a first indication indicating that usage data for a QoS flow of a terminal device is to be collected and reported.

At block 820, the first network device 110 collects the usage data based on the first indication.

At block 830, the first network device 110 transmits, to a second network device, a usage data report associated with the collected usage data.

In some embodiments, obtaining the first indication comprises: receiving a QoS profile associated with the QoS flow from the second network device, the QoS profile comprising PDU set QoS parameters. The PDU set QoS parameters indicates that the usage data is to be collected and reported.

In some embodiments, the PDU set QoS parameters further indicate that at least one of the following is to be collected and reported: first usage data to which PDU set handling is applied, or second usage data to which the PDU set handling is not applied.

In some embodiments, the method 800 further comprises: transmitting an acceptance indication to the second network device. The acceptance indication indicates whether the PDU set QoS parameters are accepted.

In some embodiments, obtaining the first indication comprises: receiving a usage data report indicator from the second network device. The usage data report indicator indicates that the usage data is to be collected and reported.

In some embodiments, the first indication comprises a pre-configured usage data report indicator which indicates that the usage data is to be collected and reported.

In some embodiments, the usage data report indicator indicates at least one of the following is to be collected and reported: first usage data to which PDU set handling is applied, or second usage data to which the PDU set handling is not applied.

In some embodiments, transmitting the usage data report comprises transmitting the usage data report based on determining one of the following: PDU set handling changes, handover of the terminal device is performed, a third network device serving the terminal device is added or modified, or the terminal device enters a Radio Resource Control (RRC)-inactive mode or an RRC-idle mode.

In some embodiments, transmitting the usage data report comprises: transmitting first usage data in a first information element (IE) associated with PDU set handling; and transmitting second usage data in a second IE associated with non-PDU set handling.

In some embodiments, the usage data report comprises at least one of the following: first usage data and a second indication indicates that PDU set handling is applied to the first usage data, or second usage data and a third indication indicates that the PDU set handling is not applied to the second usage data; and

In some embodiments, the usage data report comprises the usage data and one of the following: a first percentage of the usage data to which PDU set handling is applied, or a second percentage of the usage data to which the PDU set handling is not applied.

In some embodiments, the usage data report comprises at least one of the following: third usage data for the first network device, or fourth usage data for a third network device serving the terminal device.

In some embodiments, the third usage data comprises at least one of the following: a first subset of usage data to which PDU set handling is applied, or a second subset of usage data to which the PDU set handling is not applied; and the fourth usage data comprises at least one of the following: a third subset of usage data to which the PDU set handling is applied, or a fourth subset of usage data to which the PDU set handling is not applied.

In some embodiments, the method 800 further comprises: transmitting a support indication to the second network device. The support indication indicates whether PDU set handling is supported by the first network device.

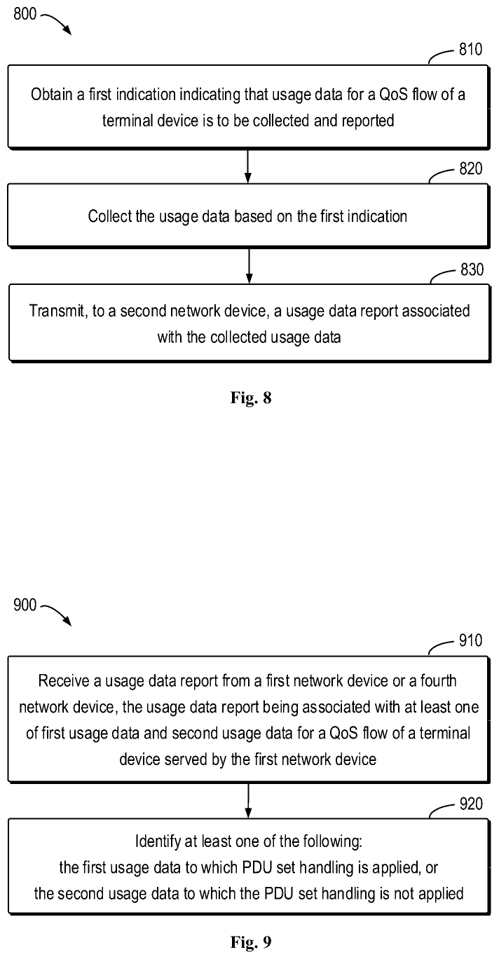

FIG. 9 illustrates a flowchart of a method 900 implemented at a second network device in accordance with some embodiments of the present disclosure. For the purpose of discussion, the method 900 will be described from the perspective of the second network device 120 with reference to FIG. 1.

At block 910, the second network device 120 receives a usage data report from a first network device or a fourth network device. The usage data report is associated with at least one of first usage data and second usage data for a QoS flow of a terminal device served by the first network device.

At block 920, the second network device 120 identifies at least one of the following: the first usage data to which PDU set handling is applied, or the second usage data to which the PDU set handling is not applied.

In some embodiments, the method 900 further comprises: receiving an acceptance indication from the first network device. The acceptance indication indicates whether PDU set QoS parameters in a QoS profile associated with the QoS flow are accepted; and identifying at least one of the first usage data and the second usage data comprises identifying at least one of the first usage data and the second usage data based on the acceptance indication.

In some embodiments, identifying at least one of the first usage data and the second usage data comprises identifying the first usage data based on determining that the first usage data is received in a first information element (IE) associated with the PDU set handling; and identifying the second usage data based on determining that the second usage data is received in a second IE associated with non-PDU set handling.

In some embodiments, the usage data report comprises at least one of the following: the first usage data and a second indication indicating that the PDU set handling is applied to the first usage data; or the second usage data and a third indication indicating that the PDU set handling is not applied to the second usage data; and identifying at least one of the first usage data and the second usage data comprises identifying the first usage data based on the second indication and identifying the second usage data based on the third indication.

In some embodiments, the method 900 further comprises: receiving a support indication from the first network device. The support indication indicates whether the PDU set handling is supported by the first network device. Identifying at least one of the first usage data and the second usage data comprises identifying at least one of the first usage data and the second usage data based on the support indication.

In some embodiments, the method 900 further comprises: transmitting, to the first network device or the fourth network device, a usage data report indicator indicating that usage data for the QoS flow is to be collected and reported.

In some embodiments, the usage data report indicator comprises a differentiating usage data report indicator indicating that the first usage data and the second usage data is to be collected and reported.

In some embodiments, the method 900 further comprises: transmitting, to the first network device, a first reporting trigger for the usage data report, the first reporting trigger comprising one of the following: the PDU set handling changes, handover of the terminal device is performed, a third network device serving the terminal device is added or modified, or the terminal device enters an inactive mode or an idle mode.

In some embodiments, the method 900 further comprises: transmitting, to the fourth network device, a second reporting trigger for the usage data report, the second reporting trigger comprising one of the following: a sum of a first volume of the first usage data and a second volume of the second usage data exceeds a volume threshold, time for handling the sum of the first volume and the second volume exceeds a time threshold, the PDU set handling changes, the first volume of the first usage data exceeds a first volume threshold, the second volume of the second usage data exceeds a second volume threshold, first time for handling the first volume exceeds a first time threshold, or second time for handling the second volume exceeds a second time threshold.

In some embodiments, the method 900 further comprises: transmitting, to the fourth network device, at least one of the following: the volume threshold, the time threshold, the first volume threshold, the second volume threshold, the first time threshold, or the second time threshold.

In some embodiments, the method 900 further comprises: transmitting, to the fourth network device, an indication indicating whether the PDU set handling is activated.

In some embodiments, the method 900 further comprises: receiving, from the first network device, information about dropped packets; and updating usage data for the QoS flow based on the usage data report from the fourth network device and the information.

In some embodiments, the information comprises an indication that a volume of the dropped packets exceeds a volume threshold or a dropped packet ratio exceeds a ratio threshold.

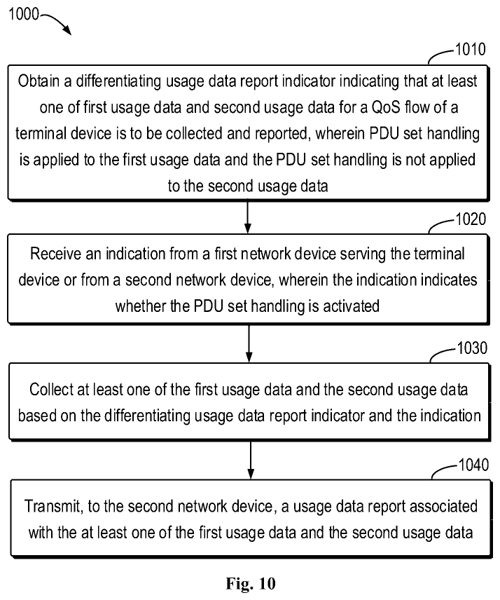

FIG. 10 illustrates a flowchart of a method 1000 implemented at a fourth network device in accordance with some embodiments of the present disclosure. For the purpose of discussion, the method 1000 will be described from the perspective of the fourth network device 140 with reference to FIG. 1.

At block 1010, the fourth network device 140 obtains a differentiating usage data report indicator indicating that at least one of first usage data and second usage data for a QoS flow of a terminal device is to be collected and reported. PDU set handling is applied to the first usage data and the PDU set handling is not applied to the second usage data.

At block 1020, the fourth network device 140 receives an indication from a first network device serving the terminal device or from a second network device. The indication indicates whether the PDU set handling is activated.

At block 1030, the fourth network device 140 collects at least one of the first usage data and the second usage data based on the differentiating usage data report indicator and the indication.

At block 1030, the fourth network device 140 transmits, to the second network device, a usage data report associated with the at least one of the first usage data and the second usage data.

In some embodiments, transmitting the usage data report comprises transmitting the usage data report based on determining a second reporting trigger is met. The second reporting trigger comprises one of the following: a sum of a first volume of the first usage data and a second volume of the second usage data exceeds a volume threshold, time for handling the sum of the first volume and the second volume exceeds a time threshold, the PDU set handling changes, the first volume of the first usage data exceeds a first volume threshold, the second volume of the second usage data exceeds a second volume threshold, first time for handling the first volume exceeds a first time threshold, or second time for handling the second volume exceeds a second time threshold.

In some embodiments, the method 1000 further comprises: receiving, from the second network device, at least one of the following: the volume threshold, the time threshold, the first volume threshold, the second volume threshold, the first time threshold, or the second time threshold.

In some embodiments, obtaining the differentiating usage data report indicator comprises obtaining the differentiating usage data report indicator from the second network device.

In some embodiments, the differentiating usage data report indicator is pre-configured.

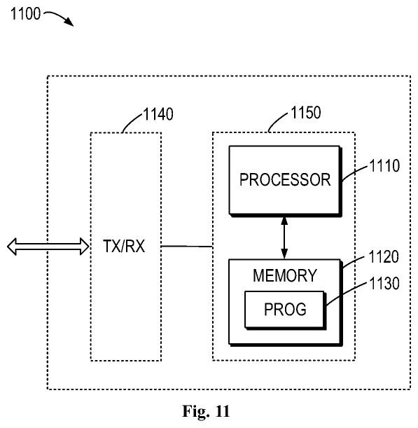

FIG. 11 illustrates a simplified block diagram of an apparatus 1100 that is suitable for implementing embodiments of the present disclosure. The apparatus 1100 can be considered as a further example implementation of the first network device 110, the second network device 120 or the fourth network device 140 as shown in FIG. 1. Accordingly, the apparatus 1100 can be implemented at or as at least a part of the first network device 110, the second network device 120 or the fourth network device 140.

As shown, the apparatus 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1130 is assumed to include program instructions that, when executed by the associated processor 1110, enable the apparatus 1100 to operate in accordance with the embodiments of the present disclosure, as discussed herein with reference to FIGS. 1 to 10. The embodiments herein may be implemented by computer software executable by the processor 1110 of the apparatus 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1120 is shown in the apparatus 1100, there may be several physically distinct memory modules in the apparatus 1100. The processor 1110 may be of any type suitable to the local technical network, and may include one or more of general purpose computers, special purpose computers, microprocessors, digital signal processors (DSPs) and processors based on multicore processor architecture, as non-limiting examples. The apparatus 1100 may have multiple processors, such as an application specific integrated circuit chip that is slaved in time to a clock which synchronizes the main processor.

In summary, embodiments of the present disclosure provide the following solutions.

Clause 1. A first network device, comprising: a processor; and a transceiver coupled to the processor, wherein the processor is configured to: obtain a first indication indicating that usage data for a Quality of Service (QoS) flow of a terminal device is to be collected and reported; collect the usage data based on the first indication; and transmit, via the transceiver to a second network device, a usage data report associated with the collected usage data.

Clause 2. The first network device of clause 1, wherein the processor is configured to obtain the first indication by: receiving a QoS profile associated with the QoS flow via the transceiver from the second network device, the QoS profile comprising Protocol Data Unit (PDU) set QoS parameters, the PDU set QoS parameters indicating that the usage data is to be collected and reported.

Clause 3. The first network device of clause 2, wherein the PDU set QoS parameters further indicate that at least one of the following is to be collected and reported: first usage data to which PDU set handling is applied, or second usage data to which the PDU set handling is not applied.

Clause 4. The first network device of clause 2, wherein the processor is further configured to: transmit an acceptance indication via the transceiver to the second network device, the acceptance indication indicating whether the PDU set QoS parameters are accepted.

Clause 5. The first network device of clause 1, wherein the processor is configured to obtain the first indication by: receiving a usage data report indicator via the transceiver from the second network device, the usage data report indicator indicating that the usage data is to be collected and reported.

Clause 6. The first network device of clause 1, wherein the first indication comprises a pre-configured usage data report indicator indicating that the usage data is to be collected and reported.

Clause 7. The first network device of clause 5 or 6, wherein the usage data report indicator indicates at least one of the following is to be collected and reported: first usage data to which Protocol Data Unit (PDU) set handling is applied, or second usage data to which the PDU set handling is not applied.

Clause 8. The first network device of clause 1, wherein the processor is configured to transmit the usage data report based on determining one of the following:
Protocol Data Unit (PDU) set handling changes,
handover of the terminal device is performed,
a third network device serving the terminal device is added or modified, or
the terminal device enters a Radio Resource Control (RRC)-inactive mode or an RRC-idle mode.

Clause 9. The first network device of clause 1, wherein the processor is configured to transmit the usage data report by: transmitting first usage data in a first information element (IE) associated with Protocol Data Unit (PDU) set handling; and transmitting second usage data in a second IE associated with non-PDU set handling.

Clause 10. The second network device of clause 1, wherein the usage data report comprises at least one of the following: first usage data and a second indication indicating that Protocol Data Unit (PDU) set handling is applied to the first usage data, or second usage data and a third indication indicating that the PDU set handling is not applied to the second usage data; and

Clause 11. The first network device of clause 1, wherein the usage data report comprises the usage data and one of the following: a first percentage of the usage data to which Protocol Data Unit (PDU) set handling is applied, or a second percentage of the usage data to which the PDU set handling is not applied.

Clause 12. The first network device of clause 1, wherein the usage data report comprises at least one of the following: third usage data for the first network device, or fourth usage data for a third network device serving the terminal device.

Clause 13. The first network device of clause 12, wherein the third usage data comprises at least one of the following: a first subset of usage data to which Protocol Data Unit (PDU) set handling is applied, or a second subset of usage data to which the PDU set handling is not applied; and the fourth usage data comprises at least one of the following: a third subset of usage data to which the PDU set handling is applied, or a fourth subset of usage data to which the PDU set handling is not applied.

Clause 14. The first network device of clause 1, wherein the processor is further configured to: transmit a support indication via the transceiver to the second network device, the support indication indicating whether Protocol Data Unit (PDU) set handling is supported by the first network device.

Clause 15. A second network device, comprising: a processor; and a transceiver coupled to the processor, wherein the processor is configured to: receive a usage data report via the transceiver from a first network device or a fourth network device, the usage data report being associated with at least one of first usage data and second usage data for a Quality of Service (QoS) flow of a terminal device served by the first network device; and identify at least one of the following: the first usage data to which Protocol Data Unit (PDU) set handling is applied, or the second usage data to which the PDU set handling is not applied.

Clause 16. The second network device of clause 15, wherein: the processor is further configured to: receive an acceptance indication via the transceiver from the first network device, the acceptance indication indicating whether PDU set QoS parameters in a QoS profile associated with the QoS flow are accepted; and the processor is configured to identify at least one of the first usage data and the second usage data based on the acceptance indication.

Clause 17. The second network device of clause 15, wherein the processor is configured to identify the first usage data based on determining that: the first usage data is received in a first information element (IE) associated with the PDU set handling; and the processor is configured to identify the second usage data based on determining that: the second usage data is received in a second IE associated with non-PDU set handling.

Clause 18. The second network device of clause 15, wherein: the usage data report comprises at least one of the following: the first usage data and a second indication indicating that the PDU set handling is applied to the first usage data; or the second usage data and a third indication indicating that the PDU set handling is not applied to the second usage data; and the processor is configured to identify the first usage data based on the second indication and identify the second usage data based on the third indication.

Clause 19. The second network device of clause 15, wherein: the processor is further configured to: receive a support indication via the transceiver from the first network device, the support indication indicating whether the PDU set handling is supported by the first network device; and the processor is configured to identify at least one of the first usage data and the second usage data based on the support indication.

Clause 20. The second network device of clause 15, wherein the processor is further configured to: transmit, via the transceiver to the first network device or the fourth network device, a usage data report indicator indicating that usage data for the QoS flow is to be collected and reported.

Clause 21. The second network device of clause 20, wherein the usage data report indicator comprises a differentiating usage data report indicator indicating that the first usage data and the second usage data is to be collected and reported.

Clause 22. The second network device of clause 15, wherein the processor is further configured to: transmit, via the transceiver to the first network device, a first reporting trigger for the usage data report, the first reporting trigger comprising one of the following: the PDU set handling changes, handover of the terminal device is performed, a third network device serving the terminal device is added or modified, or the terminal device enters an inactive mode or an idle mode.

Clause 23. The second network device of clause 15, wherein the processor is further configured to: transmit, via the transceiver to the fourth network device, a second reporting trigger for the usage data report, the second reporting trigger comprising one of the following:
a sum of a first volume of the first usage data and a second volume of the second usage data exceeds a volume threshold,
time for handling the sum of the first volume and the second volume exceeds a time threshold,
the PDU set handling changes,
the first volume of the first usage data exceeds a first volume threshold,
the second volume of the second usage data exceeds a second volume threshold,
first time for handling the first volume exceeds a first time threshold, or
second time for handling the second volume exceeds a second time threshold.

Clause 24. The second network device of clause 23, wherein the processor is further configured to transmit, via the transceiver to the fourth network device, at least one of the following:
the volume threshold,
the time threshold,
the first volume threshold,
the second volume threshold,
the first time threshold, or
the second time threshold.

Clause 25. The second network device of clause 15, wherein the processor is further configured to: transmit, via the transceiver to the fourth network device, an indication indicating whether the PDU set handling is activated.

Clause 26. The second network device of clause 15, wherein the processor is further configured to: receive, via the transceiver from the first network device, information about dropped packets; and update usage data for the QoS flow based on the usage data report from the fourth network device and the information.

Clause 27. The second network device of clause 15, wherein the information comprises an indication that a volume of the dropped packets exceeds a volume threshold or a dropped packet ratio exceeds a ratio threshold.

Clause 28. A fourth network device, comprising: a processor; and a transceiver coupled to the processor, wherein the processor is configured to: obtain a differentiating usage data report indicator indicating that at least one of first usage data and second usage data for a Quality of Service (QoS) flow of a terminal device is to be collected and reported, wherein Protocol Data Unit (PDU) set handling is applied to the first usage data and the PDU set handling is not applied to the second usage data; receive an indication via the transceiver from a first network device serving the terminal device or from a second network device, wherein the indication indicates whether the PDU set handling is activated; collect at least one of the first usage data and the second usage data based on the differentiating usage data report indicator and the indication; and transmit, via the transceiver to the second network device, a usage data report associated with the at least one of the first usage data and the second usage data.

Clause 29. The fourth network device of clause 28, wherein the processor is configured to transmit the usage data report based on determining a second reporting trigger is met, the second reporting trigger comprising one of the following:
a sum of a first volume of the first usage data and a second volume of the second usage data exceeds a volume threshold,
time for handling the sum of the first volume and the second volume exceeds a time threshold,
the PDU set handling changes,
the first volume of the first usage data exceeds a first volume threshold,
the second volume of the second usage data exceeds a second volume threshold,
first time for handling the first volume exceeds a first time threshold, or
second time for handling the second volume exceeds a second time threshold.

Clause 30. The fourth network device of clause 29, wherein the processor is further configured to receive, via the transceiver from the second network device, at least one of the following:
the volume threshold,
the time threshold,
the first volume threshold,
the second volume threshold,
the first time threshold, or
the second time threshold.

Clause 31. The fourth network device of clause 28, wherein the processor is configured to obtain the differentiating usage data report indicator from the second network device.

Clause 32. The fourth network device of clause 28, wherein the differentiating usage data report indicator is pre-configured.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first network device for wireless communication, comprising:
at least one memory; and
at least one processor coupled with the at least one memory and configured to cause first network device to:
obtain a first indication indicating that usage data for a quality of service (QoS) flow of a terminal device is to be collected and reported;
collect the usage data based at least in part on the first indication; and
transmit a usage data report associated with the collected usage data.

2. The first network device of claim 1, wherein to obtain the first indication, the at least one processor is configured to cause the first network device to:
receive a QoS profile associated with the QoS flow, the QoS profile comprising protocol data unit (PDU) set QoS parameters, the PDU set QoS parameters indicating that the usage data is to be collected and reported.

3. The first network device of claim 2, wherein the PDU set QoS parameters further indicate that at least one of first usage data to which PDU set handling is applied is to be collected and reported, or second usage data to which the PDU set handling is not applied is to be collected and reported.

4. The first network device of claim 2, wherein the at least one processor is further configured to cause the first network device to:
transmit an acceptance indication indicating whether the PDU set QoS parameters are accepted.

5. The first network device of claim 1, wherein a usage data report indicator indicates at least one of first usage data to which protocol data unit (PDU) set handling is applied is to be collected and reported, or second usage data to which the PDU set handling is not applied is to be collected and reported.

6. The first network device of claim 1, wherein to transmit the usage data report, the at least one processor is configured to cause the first network device to transmit the usage data report based at least in part on a determination of:
protocol data unit (PDU) set handling changes,
handover of the terminal device is performed,
a third network device serving the terminal device is added or modified, or
the terminal device enters a radio resource control (RRC)-inactive mode or an RRC-idle mode.

7. The first network device of claim 1, wherein the at least one processor is further configured to cause the first network device to:
transmit a support indication indicating whether protocol data unit (PDU) set handling is supported by the first network device.

8. A second network device, comprising:
at least one memory; and
at least one processor coupled with the at least one memory and configured to cause second network device to:
receive a usage data report associated with at least one of first usage data and second usage data for a quality of service (QoS) flow of a terminal device served by a first network device; and
identify at least one of:
first usage data to which protocol data unit (PDU) set handling is applied, or
second usage data to which the PDU set handling is not applied.

9. The second network device of claim 8, wherein the at least one processor is further configured to cause the second network device to:
receive an acceptance indication indicating whether PDU set QoS parameters in a QoS profile associated with the QoS flow are accepted; and
identify at least one of the first usage data and the second usage data based at least in part on the acceptance indication.

10. The second network device of claim 8, wherein the at least one processor is further configured to cause the second network device to:
receive a support indication indicating whether the PDU set handling is supported by the first network device; and
identify at least one of the first usage data and the second usage data based at least in part on the support indication.

11. The second network device of claim 8, wherein the at least one processor is further configured to cause the second network device to:
transmit a first reporting trigger for the usage data report, the first reporting trigger comprising one of:
PDU set handling changes,
handover of the terminal device is performed,
a third network device serving the terminal device is added or modified, or the terminal device enters an inactive mode or an idle mode.

12. The second network device of claim 8, wherein the at least one processor is further configured to cause the second network device to:
transmit an indication indicating to activate the PDU set handling.

13. The second network device of claim 8, wherein the at least one processor is further configured to cause the second network device to:
receive information about dropped packets; and
update usage data for the QoS flow based at least in part on the usage data report from a fourth network device and the information.

14. The second network device of claim 13, wherein the information comprises an indication that a volume of the dropped packets exceeds a volume threshold or a dropped packet ratio exceeds a ratio threshold.

15. A fourth network device, comprising:
at least one memory; and
at least one processor coupled with the at least one memory and configured to cause fourth network device to:
obtain a differentiating usage data report indicator indicating that at least one of first usage data and second usage data for a quality of service (QoS) flow of a terminal device is to be collected and reported, wherein protocol data unit (PDU) set handling is applied to the first usage data and the PDU set handling is not applied to the second usage data;
receive an indication indicating whether the PDU set handling is activated;
collect at least one of the first usage data and the second usage data based at least in part on the differentiating usage data report indicator and the indication; and
transmit a usage data report associated with the at least one of the first usage data and the second usage data.

16. A method performed by a first network device, the method comprising:
obtaining a first indication indicating that usage data for a quality of service (QoS) flow of a terminal device is to be collected and reported;
collecting the usage data based at least in part on the first indication; and
transmitting a usage data report associated with the collected usage data.

17. The method of claim 16, wherein obtaining the first indication comprises:
receiving a QoS profile associated with the QoS flow, the QoS profile comprising protocol data unit (PDU) set QoS parameters, the PDU set QoS parameters indicating that the usage data is to be collected and reported.

18. The method of claim 16, wherein a usage data report indicator indicates at least one of first usage data to which protocol data unit (PDU) set handling is applied is to be collected and reported, or second usage data to which the PDU set handling is not applied is to be collected and reported.

19. The method of claim 16, wherein transmitting the usage data report comprises transmitting the usage data report based at least in part on determining:
protocol data unit (PDU) set handling changes,
handover of the terminal device is performed,
a third network device serving the terminal device is added or modified, or
the terminal device enters a radio resource control (RRC)-inactive mode or an RRC-idle mode.

20. The method of claim 16, further comprising:
transmitting a support indication indicating whether protocol data unit (PDU) set handling is supported by the first network device.
